(19) United States
(12) Patent Application Publication
(10) Pub. No.: US 2013/0208171 A1
(43) Pub. Date: Aug. 15, 2013

(54) FOUR-PIECE OPTICAL LENS SYSTEM

(71) Applicant: Shu-Tzu Lai, Taichung City (TW)

(72) Inventor: Shu-Tzu Lai, Taichung City (TW)

(21) Appl. No.: 13/397,502

(22) Filed: Feb. 15, 2012

(51) Int. Cl. H04N 5/225

(52) U.S. Cl. 348/340; 348/E05.024

(57) ABSTRACT

A four-piece optical lens system comprises, in order from the object side to the image side: a first lens element with a positive refractive power having a convex image-side surface and at least one aspheric surface; a stop, a second lens element with a negative refractive power having a concave image-side surface and at least one aspheric surface; a third lens element with a positive refractive power having a convex image-side surface and at least one aspheric surface; a fourth lens element with a negative refractive power having a concave object-side surface and at least one aspheric surface. A distance from an object-side surface of the first lens element to an image plane is TL, an electronic sensor is provided on the image plane, half of the diagonal length of the electronic sensor's effective pixel region is ImgH, and they satisfy the relation: TL/ImgH<1.6.

### BACKGROUND OF THE INVENTION

1. Field of the Invention

The present invention relates to an optical lens system, and more particularly to a four-piece optical lens system.

2. Description of the Prior Art

In recent years, with the popularity of the mobile phone cameras, the optical lens system has become smaller in size, and the electronic sensor of a general digital camera is typically a CCD (Charge Coupled Device) or CMOS (Complementary Metal Oxide Semiconductor) sensor. Due to advances in semiconductor manufacturing, the pixel size of sensor has been reduced continuously, and miniaturized optical lens systems have increasingly higher resolution. Therefore, there's an increasing demand for an imaging lens system with better image quality.

Conventional miniaturized lens systems mostly consist of three lens elements, from the object side to the image side: a first lens element with a positive refractive power, a second lens element with a negative refractive power and a third lens element with a positive refractive power. However, as the pixel size of electronic imaging sensors gradually becomes smaller and smaller, and the system requires higher image quality, the conventional optical lens system comprising three lens elements cannot satisfy the requirements of higher resolution optical lens systems.

Hence, a four-piece lens system consisting of four lens elements is used in mobile phone so as to solve the problem that the three-piece optical lens system cannot satisfy the requirements of higher resolution optical lens systems. However, the resolution of the mobile phone camera has been improved rapidly, the pixel size of electronic imaging sensors gradually becomes smaller and smaller, and the system requires higher image quality, there's an increasing demand for an optical lens system which has a wide field of view, high pixel, high resolution and low height.

The present invention mitigates and/or obviates the aforementioned disadvantages.

### SUMMARY OF THE INVENTION

The primary objective of the present invention is to provide a four-piece optical lens system without having an excessively long total track length, the four-piece optical lens system not only can be applied to a high resolution mobile phone, but also has a wide field of view, high pixel, high resolution and low height.

A four-piece optical lens system in accordance with the present invention comprises, in order from the object side to the image side: a first lens element with a positive refractive power having a convex image-side surface, at least one of an object-side and the image-side surfaces of the first lens element being aspheric; a stop; a second lens element with a negative refractive power having a concave image-side surface, at least one of an object-side and the image-side surfaces of the second lens element being aspheric; a third lens element with a positive refractive power having a convex image-side surface, at least one of an object-side and the image-side surfaces of the third lens element being aspheric; and a fourth lens element with a negative refractive power having a concave object-side surface, at least one of the object-side and an image-side surfaces of the fourth lens element being aspheric. The distance between the object-side surface of the first lens element and the image plane is TL, an electronic sensor is provided on the image plane, half of the diagonal length of the electronic sensor's effective pixel region is ImgH, and they satisfy the relation:

TL/ImgH<1.6.

According to one aspect of the present four-piece optical lens system, the focal length of the first lens element is f1, the focal length of the second lens element is f2, and they satisfy the relation: 0.3<|f1|/|f2|<0.8. If |f1|/|f2| satisfies the above relation, a wide field of view, high pixel, high resolution and low height can be provided and the resolution can be improved evidently. Contrarily, If |f1|/|f2| exceeds the above range, the performance and resolution of the optical lens system with a wide field of view will be reduced, and the yield rate will be low.

According to another aspect of the present four-piece optical lens system, the focal length of the second lens element is f2, the focal length of the third lens element is f3, and they satisfy the relation: 1.3<|f2|/|f3|<2.0. If |f2|/|f3| satisfies the above relation, a wide field of view, high pixel, high resolution and low height can be provided and the resolution can be improved evidently. Contrarily, If |f2|/|f3| exceeds the above range, the performance and resolution of the optical lens system with a wide field of view will be reduced, and the yield rate will be low.

According to another aspect of the present four-piece optical lens system, the focal length of the third lens element is f3, the focal length of the fourth lens element is f4, and they satisfy the relation: 0.8<|f3|/|f4|<1.5. If |f3|/|f4| satisfies the above relation, a wide field of view, high pixel, high resolution and low height can be provided and the resolution can be improved evidently. Contrarily, If |f3|/|f4| exceeds the above range, the performance and resolution of the optical lens system with a wide field of view will be reduced, and the yield rate will be low.

According to another aspect of the present four-piece optical lens system, the focal length of the first lens element and the second lens element combined is f12, the focal length of the third lens element and the fourth lens element combined is f34, and they satisfy the relation: |f12|/|f34|<0.06. If |f12|/|f34| satisfies the above relation, a wide field of view, high pixel, high resolution and low height can be provided and the resolution can be improved evidently. Contrarily, If |f12|/|f34| exceeds the above range, the performance and resolution of the optical lens system with a wide field of view will be reduced, and the yield rate will be low.

According to another aspect of the present four-piece optical lens system, the focal length of the first lens element is f1, the focal length of the second lens element, the third lens element and the fourth lens element combined is f234, and they satisfy the relation: 0.4<|f1|/|f234|<0.9. If |f1|/|f234| satisfies the above relation, a wide field of view, high pixel, high resolution and low height can be provided and the resolution can be improved evidently. Contrarily, If |f1|/|f234| exceeds the above range, the performance and resolution of the optical lens system with a wide field of view will be reduced, and the yield rate will be low.

According to another aspect of the present four-piece optical lens system, the focal length of the second lens element and the third lens element combined is f23, the focal length of the four-piece optical lens system is f, and they satisfy the relation: 0.6<|f23|/|f|<1.2. If |f23|/|f| satisfies the above relation, a wide field of view, high pixel, high resolution and low height can be provided and the resolution can be improved evidently. Contrarily, If |f23|/|f| exceeds the above range, the performance and resolution of the optical lens system with a wide field of view will be reduced, and the yield rate will be low.

According to another aspect of the present four-piece optical lens system, the focal length of the four-piece optical lens system is f, the distance between the object-side surface of the first lens element and the image plane is TL, and they satisfy the relation: 0.75<|f/TL|<0.95. If |f/TL| satisfies the above relation, the total track length of the optical lens system can be relatively short, and the requirement of miniaturization can be satisfied.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows an optical lens system in accordance with a first embodiment of the present invention;

FIG. 1B shows the longitudinal spherical aberration curve, the astigmatic field curve, and the distortion curve of the first embodiment of the present invention;

FIG. 2A shows an optical lens system in accordance with a second embodiment of the present invention; and

FIG. 2B shows the longitudinal spherical aberration curve, the astigmatic field curve, and the distortion curve of the second embodiment of the present invention.

### DETAILED DESCRIPTION OF THE PREFERRED EMBODIMENTS

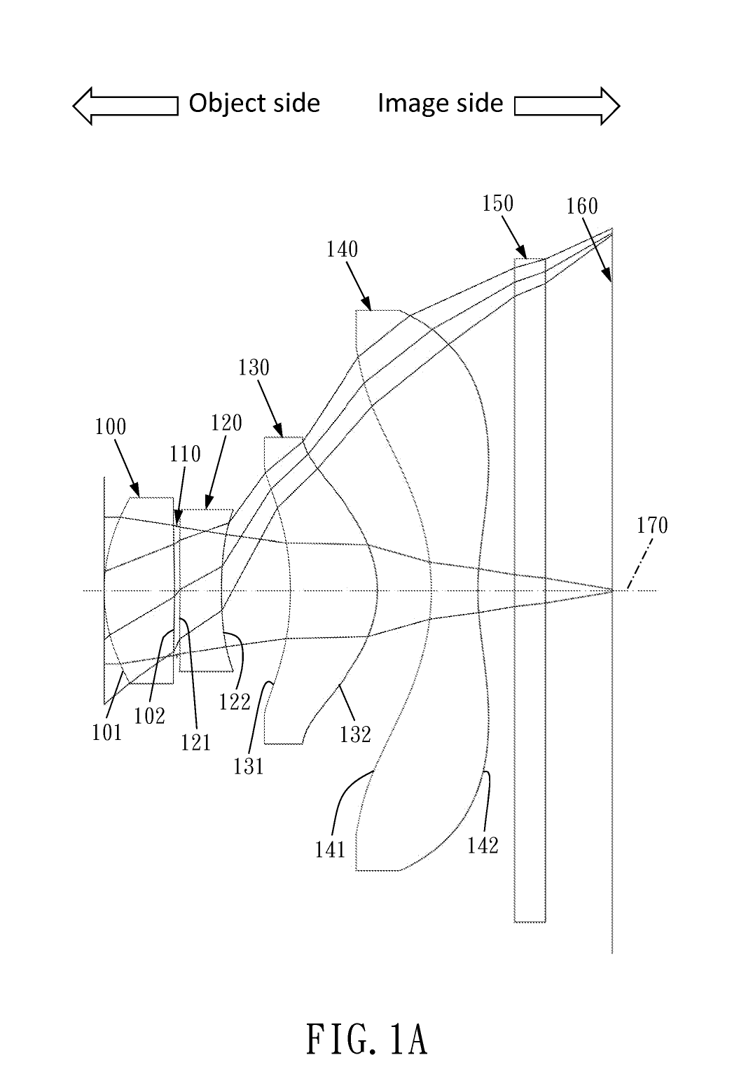

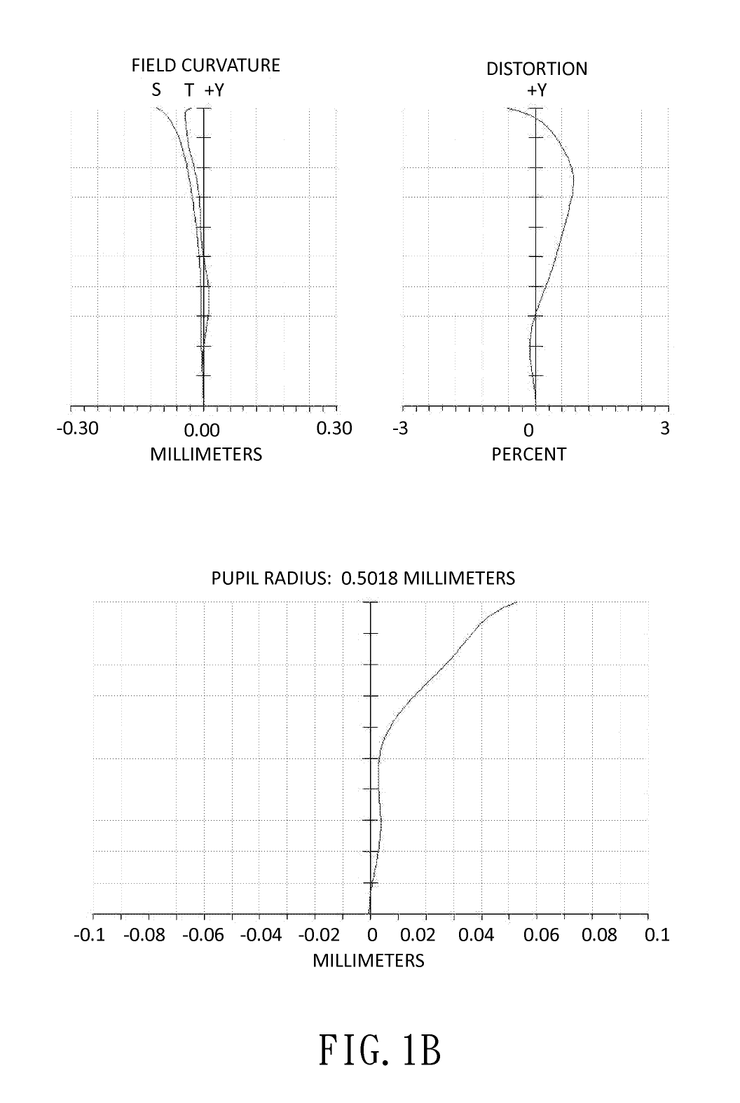

Referring to FIG. 1A, which shows a four-piece optical lens system in accordance with a first embodiment of the present invention, and FIG. 1B shows the longitudinal spherical aberration curves, the astigmatic field curves, and the distortion curve of the first embodiment of the present invention. A four-piece optical lens system in accordance with the first embodiment of the present invention comprises, in order from the object side A to the image side B:

A first lens element 100 with a positive refractive power made of plastic has a convex object-side surface 101 and a convex image-side surface 102, and the object-side surface 101 and the image-side surface 102 of the first lens element 100 are aspheric.

A stop 110.

A second lens element 120 with a negative refractive power made of plastic has a concave object-side surface 121 and a concave image-side surface 122, and the object-side surface 121 and the image-side surface 122 of the second lens element 120 are aspheric.

A third lens element 130 with a positive refractive power made of plastic has a concave object-side surface 131 and a convex image-side surface 132, and the object-side surface 131 and the image-side surface 132 of the third lens element 130 are aspheric.

A fourth lens element 140 with a negative refractive power made of plastic has a concave object-side surface 141 and a concave image-side surface 142, and the object-side surface 141 and the image-side surface 142 of the fourth lens element 140 are aspheric.

An IR cut filter 150 made of glass is located between the image-side surface 142 of the fourth lens element 140 and an image plane 160 and has no influence on the focal length of the four-piece optical lens system.

The equation for the aspheric surface profiles of the first embodiment is expressed as follows:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Gh}^{14} + …$$

wherein:

z represents the value of a reference position with respect to a vertex of the surface of a lens and a position with a height h along the optical axis 170;

k represents the conic constant;

c represents the reciprocal of the radius of curvature;

A, B, C, D, E, G, . . . : represent the high-order aspheric coefficients.

In the first embodiment of the present four-piece optical lens system, the focal length of the four-piece optical lens system is f, and it satisfies the relation:

f=2.95.

In the first embodiment of the present four-piece optical lens system, the f-number of the four-piece optical lens system is Fno, and it satisfies the relation:

Fno=2.8.

In the first embodiment of the present four-piece optical lens system, the field of view of the four-piece optical lens system is 2ω, and it satisfies the relation:

2ω=79°.

In the first embodiment of the present four-piece optical lens system, the distance between the object-side surface 101 of the first lens element 100 and the image plane 160 is TL, an electronic sensor (not shown) is provided on the image plane 160, half of the diagonal length of the electronic sensor's effective pixel region is ImgH, and they satisfy the relation:

TL/ImgH=1.512.

In the first embodiment of the present four-piece optical lens system, the focal length of the first lens element 100 is f1, the focal length of the second lens element 120 is f2, and they satisfy the relation:

|f1|/|f2|=0.594.

In the first embodiment of the present four-piece optical lens system, the focal length of the second lens element 120 is f2, the focal length of the third lens element 130 is f3, and they satisfy the relation:

|f2|/|f3|=1.696.

In the first embodiment of the present four-piece optical lens system, the focal length of the third lens element 130 is f3, the focal length of the fourth lens element 140 is f4, and they satisfy the relation:

|f3|/|f4|=1.196.

In the first embodiment of the present four-piece optical lens system, the focal length of the first lens element 100 and the second lens element 120 combined is f12, the focal length of the third lens element 130 and the fourth lens element 140 combined is f34, and they satisfy the relation:

|f12|/|f34|=0.044.

In the first embodiment of the present four-piece optical lens system, the focal length of the first lens element 100 is f1, the focal length of the second lens element 120, the third lens element 130 and the fourth lens element 140 combined is f234, and they satisfy the relation:

|f1|/|f234|=0.729.

In the first embodiment of the present four-piece optical lens system, the focal length of the second lens element 120 and the third lens element 130 combined is f23, the focal length of the four-piece optical lens system is f, and they satisfy the relation:

|f23|/|f1=0.847.

In the first embodiment of the present four-piece optical lens system, the focal length of the four-piece optical lens system is f, the distance between the object-side surface 101 of the first lens element 100 and the image plane 160 is TL, and they satisfy the relation:

|f/TL|=0.85.

The detailed optical data of the first embodiment is shown in table 1, and the aspheric surface data is shown in table 2, wherein the units of the radius of curvature, the thickness and the focal length are expressed in mm. In the tables 1 and 2, the surfaces 1 and 2 represent the object-side surface 101 and the image-side surface 102 of the first lens element 100, respectively, the surfaces 4 and 5 represent the object-side surface 121 and the image-side surface 122 of the second lens element 120, respectively, the surfaces 6 and 7 represent the object-side surface 131 and the image-side surface 132 of the third lens element 130, respectively, and the surfaces 8 and 9 represent the object-side surface 141 and the image-side surface 142 of the fourth lens element 140, respectively.

TABLE 1
(Embodiment 1)
f (focal length) = 2.95 mm, Fno = 2.8, 2ω = 79°.

| Surface # | | Curvature Radius | Thickness | Material | nd | vd |
|---|---|---|---|---|---|---|
| 0 | Object | Infinity | Infinity | | | |
| 1 | Lens 1 | 1.187063 (ASP) | 0.479795 | Plastic | 1.535 | 56 |
| 2 | | −5.23698 (ASP) | 0.016202 | | | |
| 3 | Stop | Infinity | 0.021368 | | | |
| 4 | Lens 2 | −5.7125 (ASP) | 0.282639 | Plastic | 1.632 | 23 |
| 5 | | 3.182324 (ASP) | 0.469705 | | | |
| 6 | Lens 3 | −1.99355 (ASP) | 0.599181 | Plastic | 1.535 | 56 |
| 7 | | −0.73665 (ASP) | 0.367234 | | | |
| 8 | Lens 4 | −1.66306 (ASP) | 0.317499 | Plastic | 1.535 | 56 |
| 9 | | 1.800319 (ASP) | 0.251373 | | | |
| 10 | IR-filter | Infinity | 0.21 | Glass | 1.5168 | 64.167336 |
| 11 | | Infinity | 0.455757 | | | |
| 12 | Image | Infinity | | | | |

TABLE 2
Aspheric Coefficients

| Surface # | 1 | 2 | 4 | 5 |
|---|---|---|---|---|
| K = | 0.08134 | −650.689 | −641.51 | 15.42871 |
| A = | −0.01099 | 0.243268 | 0.5303 | 0.42024 |
| B = | −0.05585 | −0.29733 | −1.02678 | −0.54774 |
| C = | −0.29345 | −0.79948 | −1.56065 | −0.65158 |
| D = | 1.735844 | −11.7787 | 0.763753 | 3.026786 |
| E = | −3.48194 | 30.6489 | 3.973683 | −3.0997 |
| Surface# | 6 | 7 | 8 | 9 |
| K = | 0.080042 | −0.78971 | −0.49043 | −22.4483 |
| A = | −0.13819 | 0.239219 | −0.008 | −0.11622 |
| B = | 0.27245 | −0.27134 | 0.046638 | 0.057817 |
| C = | −0.04876 | 0.289962 | −0.00849 | −0.02391 |
| D = | −0.19491 | 0.094574 | 2.85E−04 | 0.005053 |
| E = | 0.226499 | −0.09748 | −1.98E−05 | −4.88E−04 |

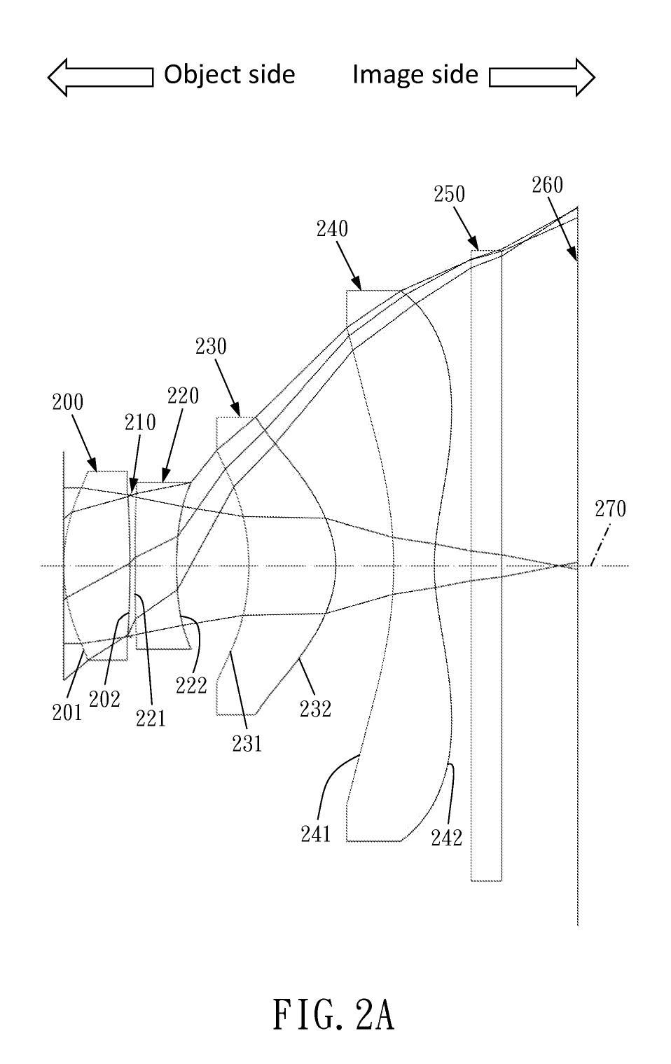

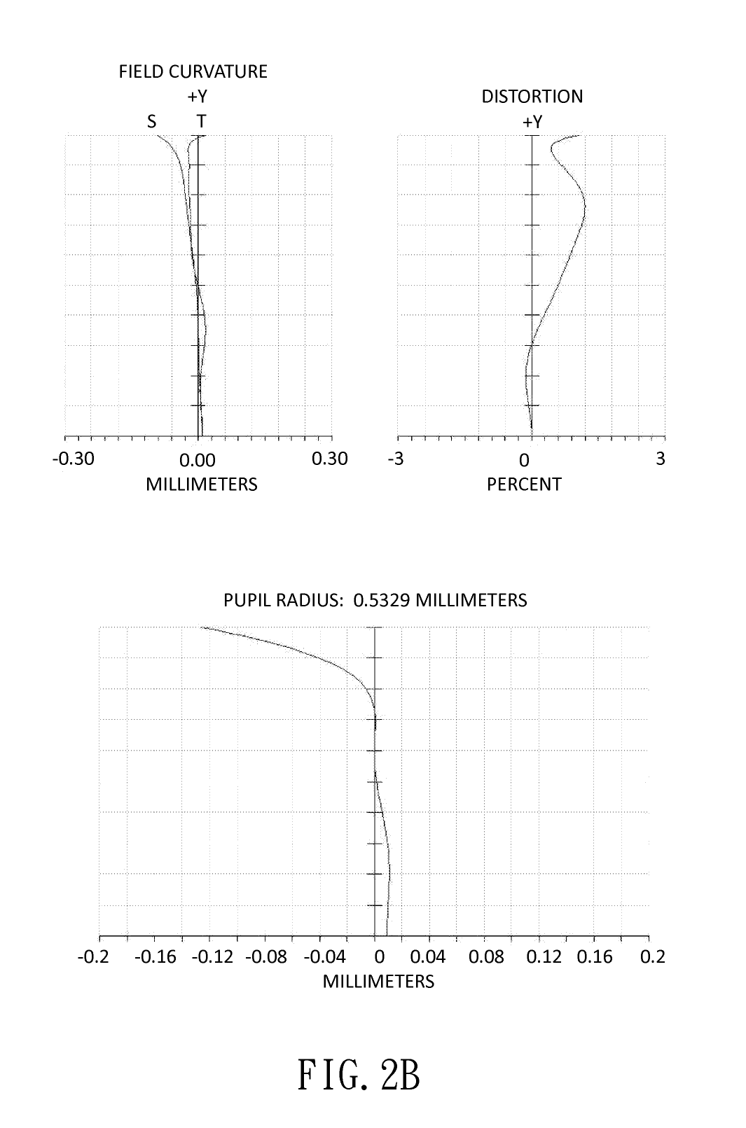

Referring to FIG. 2A, which shows a four-piece optical lens system in accordance with a second embodiment of the present invention, and FIG. 2B shows the longitudinal spherical aberration curves, the astigmatic field curves, and the distortion curve of the second embodiment of the present invention. A four-piece optical lens system in accordance with the second embodiment of the present invention comprises, in order from the object side A to the image side B:

A first lens element 200 with a positive refractive power made of plastic has a convex object-side surface 201 and a convex image-side surface 202, and the object-side surface 201 and the image-side surface 202 of the first lens element 200 are aspheric.

A stop 210.

A second lens element 220 with a negative refractive power made of plastic has a concave object-side surface 221 and a concave image-side surface 222, and the object-side surface 221 and the image-side surface 222 of the second lens element 220 are aspheric.

A third lens element 230 with a positive refractive power made of plastic has a concave object-side surface 231 and a convex image-side surface 232, and the object-side surface 231 and the image-side surface 232 of the third lens element 230 are aspheric.

A fourth lens element 240 with a negative refractive power made of plastic has a concave object-side surface 241 and a concave image-side surface 242, and the object-side surface 241 and the image-side surface 242 of the fourth lens element 240 are aspheric.

An IR cut filter 250 made of glass is located between the image-side surface 242 of the fourth lens element 240 and an image plane 260 and has no influence on the focal length of the four-piece optical lens system.

The equation for the aspheric surface profiles of the second embodiment is expressed as follows:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Gh}^{14} + …$$

wherein:

z represents the value of a reference position with respect to a vertex of the surface of a lens and a position with a height h along the optical axis 270;

k represents the conic constant;

c represents the reciprocal of the radius of curvature;

A, B, C, D, E, G, . . . : represent the high-order aspheric coefficients.

In the second embodiment of the present four-piece optical lens system, the focal length of the four-piece optical lens system is f, and it satisfies the relation:

f=2.95.

In the second embodiment of the present four-piece optical lens system, the f-number of the four-piece optical lens system is Fno, and it satisfies the relation:

Fno=2.8.

In the second embodiment of the present four-piece optical lens system, the field of view of the four-piece optical lens system is 2ω, and it satisfies the relation:

2ω=79°.

In the second embodiment of the present four-piece optical lens system, the distance between the object-side surface 201 of the first lens element 200 and the image plane 260 is TL, an electronic sensor (not shown) is provided on the image plane 260, half of the diagonal length of the electronic sensor's effective pixel region is ImgH, and they satisfy the relation:

TL/ImgH=1.525.

In the second embodiment of the present four-piece optical lens system, the focal length of the first lens element 200 is f1, the focal length of the second lens element 220 is f2, and they satisfy the relation:

|f1|/|f21=0.567.

In the second embodiment of the present four-piece optical lens system, the focal length of the second lens element 220 is f2, the focal length of the third lens element 230 is f3, and they satisfy the relation:

|f2|/|f3|=1.621.

In the second embodiment of the present four-piece optical lens system, the focal length of the third lens element 230 is f3, the focal length of the fourth lens element 240 is f4, and they satisfy the relation:

|f3|/|f4|=1.138.

In the second embodiment of the present four-piece optical lens system, the focal length of the first lens element 200 and the second lens element 220 combined is f12, the focal length of the third lens element 230 and the fourth lens element 240 combined is f34, and they satisfy the relation:

|f12|/|f34|=0.013.

In the second embodiment of the present four-piece optical lens system, the focal length of the first lens element 200 is f1, the focal length of the second lens element 220, the third lens element 230 and the fourth lens element 240 combined is f234, and they satisfy the relation:

|f1|/|f234|=0.65.

In the second embodiment of the present four-piece optical lens system, the focal length of the second lens element 220 and the third lens element 230 combined is f23, the focal length of the four-piece optical lens system is f, and they satisfy the relation:

|f23|/|f1=0.96.

In the second embodiment of the present four-piece optical lens system, the focal length of the four-piece optical lens system is f, the distance between the object-side surface 201 of the first lens element 200 and the image plane 260 is TL, and they satisfy the relation:

|f/TL|=0.854.

The detailed optical data of the second embodiment is shown in table 3, and the aspheric surface data is shown in table 4, wherein the units of the radius of curvature, the thickness and the focal length are expressed in mm. In the tables 3 and 4, the surfaces 1 and 2 represent the object-side surface 201 and the image-side surface 202 of the first lens element 200, respectively, the surfaces 4 and 5 represent the object-side surface 221 and the image-side surface 222 of the second lens element 220, respectively, the surfaces 6 and 7 represent the object-side surface 231 and the image-side surface 232 of the third lens element 230, respectively, and the surfaces 8 and 9 represent the object-side surface 241 and the image-side surface 242 of the fourth lens element 240, respectively.

TABLE 3
(Embodiment 2)
f (focal length) = 2.95 mm, Fno = 2.8, 2ω = 79°.

| Surface # | | Curvature Radius | Thickness | Material | nd | vd |
|---|---|---|---|---|---|---|
| 0 | Object | Infinity | Infinity | | | |
| 1 | Lens 1 | 1.20102 (ASP) | 0.452458 | Plastic | 1.535 | 56 |
| 2 | | −5.78084 (ASP) | 0.005052 | | | |
| 3 | Stop | Infinity | 0.031028 | | | |
| 4 | Lens 2 | −13.2087 (ASP) | 0.282662 | Plastic | 1.632 | 23 |
| 5 | | 2.564902 (ASP) | 0.49327 | | | |
| 6 | Lens 3 | −1.55003 (ASP) | 0.595366 | Plastic | 1.535 | 56 |
| 7 | | −0.73241 (ASP) | 0.3937 | | | |
| 8 | Lens 4 | −2.9858 (ASP) | 0.277833 | Plastic | 1.535 | 56 |
| 9 | | 1.489636 (ASP) | 0.251373 | | | |
| 10 | IR-filter | Infinity | 0.21 | Glass | 1.5168 | 64.167336 |
| 11 | | Infinity | 0.517107 | | | |
| 12 | Image | Infinity | | | | |

TABLE 4
Aspheric Coefficients

| Surface # | 1 | 2 | 4 | 5 |
|---|---|---|---|---|
| k = | −0.02611 | −459.148 | −1001.52 | 4.677911 |
| A = | −0.01649 | 0.141816 | 0.543767 | 0.357451 |
| B = | −0.1496 | −0.60007 | −1.23086 | −0.2232 |
| C = | −0.16286 | −0.62174 | −1.36576 | −0.63043 |
| D = | 1.19862 | −1.91715 | 8.182678 | 3.075736 |
| E = | −3.24571 | 6.991081 | −5.03516 | −2.88926 |
| Surface# | 6 | 7 | 8 | 9 |
| k = | 0.193499 | −0.82274 | 1.305677 | −14.3597 |
| A = | −0.13949 | 0.250641 | 0.004487 | −0.09882 |
| B = | 0.250562 | −0.26503 | 0.028747 | 0.047293 |
| C = | −0.04288 | 0.234181 | −0.00986 | −0.01801 |
| D = | −0.3481 | 0.095283 | 0.00144 | 0.003461 |
| E = | 0.572894 | −0.10273 | −5.65E−05 | −3.06E−04 |

TABLE 5

| | Embodiment 1 | Embodiment 2 |
|---|---|---|
| f | 2.95 | 2.95 |
| Fno | 2.8 | 2.8 |
| 2ω | 79 | 79 |
| TL/ImgH | 1.512 | 1.525 |
| \|f1\|/\|f2\| | 0.594 | 0.567 |
| \|f2\|/\|f3\| | 1.696 | 1.621 |
| \|f3\|/\|f4\| | 1.196 | 1.138 |
| \|f12\|/\|f34\| | 0.044 | 0.013 |
| \|f1\|/\|f234\| | 0.729 | 0.65 |
| \|f23\|/\|f\| | 0.847 | 0.96 |
| \|f\|/TL\| | 0.85 | 0.854 |

It is to be noted that the tables 1-4 show different data from the different embodiments, however, the data of the different embodiments is obtained from experiments. Therefore, any product of the same structure is deemed to be within the scope of the present invention even if it uses different data. Table 5 lists the relevant data for the various embodiments of the present invention.

In the present four-piece optical lens system, the lens elements can be made of glass or plastic. If the lens elements are made of glass, there is more freedom in distributing the refractive power of the four-piece optical lens system. If the lens elements are made of plastic, the cost will be effectively reduced.

In the present four-piece optical lens system, if the object-side or the image-side surface of the lens elements is convex, the object-side or the image-side surface of the lens elements in proximity of the optical axis is convex. If the object-side or the image-side surface of the lens elements is concave, the object-side or the image-side surface of the lens elements in proximity of the optical axis is concave.

While we have shown and described various embodiments in accordance with the present invention, it should be clear to those skilled in the art that further embodiments may be made without departing from the scope of the present invention.

What is claimed is:

1. A four-piece optical lens system comprising, in order from an object side to an image side:
a first lens element with a positive refractive power having a convex image-side surface, at least one of an object-side and the image-side surfaces of the first lens element being aspheric;
a stop;
a second lens element with a negative refractive power having a concave image-side surface, at least one of an object-side and the image-side surfaces of the second lens element being aspheric;
a third lens element with a positive refractive power having a convex image-side surface, at least one of an object-side and the image-side surfaces of the third lens element being aspheric;
a fourth lens element with a negative refractive power having a concave object-side surface, at least one of the object-side and an image-side surfaces of the fourth lens element being aspheric;
wherein a distance between an object-side surface of the first lens element and an image plane is TL, an electronic sensor is provided on the image plane, half of a diagonal length of the electronic sensor's effective pixel region is ImgH, and they satisfy the relation:
TL/ImgH<1.6.

2. The four-piece optical lens system as claimed in claim 1, wherein a focal length of the first lens element is f1, a focal length of the second lens element is f2, and they satisfy the relation:
0.3<|f1|/|f2|<0.8.

3. The four-piece optical lens system as claimed in claim 1, wherein a focal length of the second lens element is f2, a focal length of the third lens element is f3, and they satisfy the relation:
1.3<|f21/|f3|<2.0.

4. The four-piece optical lens system as claimed in claim 1, wherein a focal length of the third lens element is f3, a focal length of the fourth lens element is f4, and they satisfy the relation:
0.8<|f3|/|f4|<1.5.

5. The four-piece optical lens system as claimed in claim 1, wherein a focal length of the first lens element and the second lens element combined is f12, a focal length of the third lens element and the fourth lens element combined is f34, and they satisfy the relation:

|f12|/|f4|<0.06.

6. The four-piece optical lens system as claimed in claim 1, wherein a focal length of the first lens element is f1, a focal length of the second lens element, the third lens element and the fourth lens element combined is f234, and they satisfy the relation:
0.4<|f1|/|f234|<0.9.

7. The four-piece optical lens system as claimed in claim 1, wherein a focal length of the second lens element and the third lens element combined is f23, a focal length of the four-piece optical lens system is f, and they satisfy the relation:
0.6<|f23|/|f|<1.2.

8. The four-piece optical lens system as claimed in claim 1, wherein a focal length of the four-piece optical lens system is f, the distance between the object-side surface of the first lens element and the image plane is TL, and they satisfy the relation:
0.75<|f/TL|<0.95.

9. The four-piece optical lens system as claimed in claim 1, wherein the first, second, third and fourth lens elements are made of plastic, the object-side surface of the first lens element is convex, the object-side surface and the image-side surface of the first lens element are aspheric, the object-side surface of the second lens element is concave, the object-side surface and the image-side surface of the second lens element are aspheric, the object-side surface of the third lens element is concave, the object-side surface and the image-side surface of the third lens element are aspheric, the image-side surface of the fourth lens element is concave, and the object-side surface and the image-side surface of the fourth lens element are aspheric.
